(19) United States
(12) Patent Application Publication
(10) Pub. No.: US 2021/0360932 A1
(43) Pub. Date: Nov. 25, 2021

(54) Treatment of Mosaic Viruses and Bacterial Infections of Plants

(71) Applicant: Locus Agriculture IP Company, LLC, Solon, OH (US)

(72) Inventors: Sean FARMER, North Miami Beach, FL (US); Ken ALIBEK, Solon, OH (US); Alibek MOLDAKOZHAYEV, Solon, OH (US)

(21) Appl. No.: 16/635,372

(22) PCT Filed: Sep. 25, 2018
(86) PCT No.: PCT/US2018/052519

§ 371 Date: Jan. 30, 2020

Related U.S. Application Data
(60) Provisional application No. 62/564,517, filed on Sep. 28, 2017.

(51) Int. Cl. A01N 63/32; A01N 63/22; A01N 25/24; A01N 25/30

(52) U.S. Cl. CPC A01N 63/32; A01N 25/30; A01N 25/24; A01N 63/22

(57) ABSTRACT

Compositions and methods are provided for treating certain plant pathogens using microbe-based products. In particular, the subject invention relates to treatment of plant pathogenic viruses, including mosaic virus, as well as plant pathogenic bacteria, using beneficial microbes and/or their growth by-products. In certain embodiments, the growth by-products are biosurfactants.

### CROSS-REFERENCE TO A RELATED APPLICATION

This application claims the benefit of U.S. provisional application Ser. No. 62/564,517, filed Sep. 28, 2017, which is incorporated herein by reference in its entirety.

### BACKGROUND OF THE INVENTION

Mosaic viruses are a group of plant pathogens that affect, and can cause significant damage to, more than 150 different types of plants. Millions of growers have had portions of, or even entire crops destroyed by mosaic viruses. The most common crop plants that can become infected by mosaic viruses include potatoes, gourds, okra, chili peppers, cucumbers, muskmelons, pumpkins, tomatoes, tobacco, roses, tulips, beets, plums, beans and many more.

There are multiple species of virus that fall under the category of “mosaic” diseases, each of which belongs within one of a variety of genera, for example, Begomovirus (e.g., cassava mosaic virus), Polyvirus (e.g., plum pox virus), Tobamovirus (e.g., tobacco mosaic virus) and to a number of others. Examples of mosaic virus species include alfalfa mosaic virus, beet mosaic virus, cassava mosaic virus, cowpea mosaic virus, cucumber mosaic virus, panicum mosaic satellite virus, plum pox virus, squash mosaic virus, tobacco mosaic virus, tulip breaking virus, and zucchini yellow mosaic virus. While most of these viruses are considered ssRNA viruses, some are ssDNA viruses or are considered unassigned viruses.

Even though many of these viruses have a name “bound” to a particular plant, in reality, the same virus could have a large number of hosts. For example, although tobacco mosaic virus (TMV) is named for the first plant in which it was discovered (tobacco), it infects over 150 different types of plants. Among plants affected by TMV are vegetables, weeds and flowers. In particular, tomatoes, peppers and many ornamental plants are struck annually with this virus.

Mosaic virus damage first appears in the form of green leaves that look mottled, curled, or distorted. Typically, these leaves will develop yellowish spots on them, adding to their mottled appearance, and the plant can be stunted in growth, particularly if infected early in the season. In the curcurbit family (pumpkins, gourds, cucumbers, squash), for example, affected areas may also be covered with warts or alternately, the skins of the fruits may be faded and smooth. While mosaic virus might not kill a plant, its effect on the growth and overall health of the plant can greatly affect the amount of economically valuable products delivered by a crop. For example, fruits might become too bitter to be edible, or coloration, quality, or ripening of fruits can be disrupted.

Mosaic virus overwinters on a variety of plants including debris from plants that were not cleared from gardens or crops, as well as catnip, pokeweed, motherwort, milkweed and wild cucumber plants. Aphids and cucumber beetles spread the disease as they feed on and travel between infected plants and healthy plants. The virus can also be spread through human activity, tools and equipment. Thus, hand washing and disinfecting of garden tools, stakes, ties, pots, greenhouse benches, etc. using bleach are essential for growers to reduce the risk of contamination. The earlier in the season the disease is spread, the greater the number of plants that will have severe damage from mosaic virus. Furthermore, the virus spreads particularly easily when conditions are damp.

In addition to viral plant pathogens, bacterial plant pathogens can cause severe and economically damaging diseases as well. In contrast to viruses, however, which infect the inside of host cells, bacteria grow in the spaces between cells rather than invading them. Most plant pathogenic bacteria belong to the following genera: Erwinia, Pectobacterium, Pantoea, Agrobacterium, Pseudomonas, Ralstonia, Burkholderia, Acidovorax, Xanthomonas, Clavibacter, Streptomyces, Xylella, Spiroplasma, and Phytoplasma. Symptoms of an infection with some of these pests can include spots, mosaic patterns or pustules on leaves and fruits, smelly tuber rots, galls, overgrowths, wilts, leaf spots, specks and blights, scabs, cankers, and even plant death.

Some plant pathogenic bacteria produce toxins or inject special proteins that lead to host cell death, or they produce enzymes that break down key structural components of plant cells and their walls. These pests are spread in a variety of ways, and can travel far distances, for example, they can be splashed around by rain, or carried by wind, birds or insects, and like, viruses, can be spread by human activity. Regardless of how they are disseminated, however, bacterial pathogens must have an opening, such as a wound or a stomata, to penetrate inside the plant.

There are no cures for viral diseases such as mosaic virus once a plant is infected. Often with bacterial diseases as well, the focus is not on curing the disease, but instead on prevention of infection or spread. For example, reducing the number of disease carrying insects that come into contact with plants, or reducing the number of perennial weeds or other plants that neighbor a crop or plot can be an effective prevention measure; however, this often requires the use of harsh chemical pesticides or herbicides. Antibiotics can be used to control certain bacteria, but this can lead to resistant strains. The most effective methods thus far include the use of engineered plants that are resistant to certain strains of pest. Nonetheless, due to the vast number of different viruses and species of bacteria that can infect a plant, it can be difficult to protect against multiple pathogens using this method.

Extensive economic harm can result from widespread infection of plants and crops from certain plant diseases that can spread throughout gardens, crops, and greenhouses. This can also have a drastic effect on the supply of food crops available to consumers. Thus, there is a need for safe and environmentally-friendly methods of treating plant pathogenic viruses, including mosaic virus, as well as plant pathogenic bacteria.

### BRIEF SUMMARY OF THE INVENTION

The subject invention provides microbes, as well as by-products of their growth, such as biosurfactants, for use in treating certain plant pathogenic infections. In particular, the subject invention relates to treatment of plant pathogenic viruses, including mosaic virus, as well as plant pathogenic bacteria, using beneficial microbes and/or their growth by-products. Advantageously, the microbe-based products and methods of the subject invention are environmentally-friendly, non-toxic and cost-effective.

In certain embodiments, the subject invention provides microbe-based compositions, wherein the compositions comprise one or more beneficial microorganisms and/or one or more microbial growth by-products. The composition may also comprise the fermentation medium in which the beneficial microorganisms and/or growth by-products were produced. The microbial growth by-products can be those produced by the microorganisms of the composition, or they can be produced elsewhere and added to the composition.

In one embodiment, the composition comprises only a microbial growth by-product without the beneficial microorganism. For example, in one embodiment, the composition comprises only the fermentation broth in which the beneficial microorganism was cultivated.

Microbial growth by-products can be in a purified or crude form. In preferred embodiments, the growth by-product is a biosurfactant selected from glycolipids (e.g., sophorolipids, rhamnolipids, trehalose lipids or mannosylerythritol lipids) and lipopeptides (e.g., surfactin, iturin, lichenysin and fengycin). In one exemplary embodiment, the growth by-product is a sophorolipid (SLP).

In some embodiments, crude form biosurfactants can take the form of a liquid mixture comprising biosurfactant sediment and fermentation broth resulting from cultivation of a biosurfactant-producing microbe. This crude form biosurfactant and broth solution can comprise from about 0.001% to about 75%, from about 20% to about 70%, from about 35% to about 65%, from about 40% to about 60%, from about 45% to about 55%, or about 50% pure biosurfactant.

In certain embodiments, the beneficial microorganism according to the subject invention is a biosurfactant-producing microorganism. In specific embodiments, the microbe is a biosurfactant-producing yeast, such as, for example, Starmerella bombicola. In another embodiment, the microorganism is a biosurfactant-producing killer yeast, for example, Pichia anomala (Wickerhamomyces anomalus). These yeasts are capable of producing glycolipid biosurfactants.

In one embodiment, the beneficial microorganism is a non-pathogenic biosurfactant-producing bacteria such as, for example, Bacillus subtilis or Bacillus amyloliquefaciens. Both of these species are effective producers of certain lipopeptide biosurfactants.

The microbe-based products can be used either alone or in combination with other compounds that help enhance treatment of mosaic virus and bacterial plant pathogens.

In certain embodiments, an adherent substance can be added to the treatment to prolong the adherence of the product to plant leaves. For example, a polysaccharide-based substance, e.g., xanthan gum, can be used as an adherent for the subject compositions.

In certain embodiments, the compositions of the subject invention have advantages over, for example, purified microbial metabolites alone. These advantages can include one or more of the following: high concentrations of mannoprotein (an emulsifier) as a part of a yeast cell wall's outer surface; the presence of beta-glucan (an emulsifier) in yeast cell walls; the presence of biosurfactants in the culture; and the presence of solvents and/or other metabolites in the culture (e.g., lactic acid, ethanol, etc.).

The subject invention further provides method for cultivating the microbe-based composition. The compositions can be obtained through cultivation processes ranging from small to large scale. These cultivation processes include, but are not limited to, submerged cultivation/fermentation, solid state fermentation (SSF), and hybrids (e.g., submerged matrix systems), modifications and/or combinations thereof.

The subject invention can be used in a variety of unique settings because of, for example, the ability to efficiently deliver and use fresh fermentation broth with active metabolites; a mixture of cells, microbial propagules and/or cellular components with fermentation broth; a composition with live cells; compositions with a high density of cells, including live cells; microbe-based products on short-order; and microbe-based products in remote locations.

In some embodiments, methods are provided for treating mosaic virus and/or bacterial plant pathogens, wherein the methods comprise contacting a beneficial microorganism and/or a growth by-product of the microorganism with a part of a plant that is infected by the pathogen. In certain embodiments, the method comprises applying a microbe-based composition according to the subject description to the plant.

The microbe-based composition can be contacted directly with a plant and/or with the plant's surrounding environment. In certain embodiments, the compositions are contacted with the leaves, or foliage of an infected plant. In other embodiments, the compositions are contacted with any part of the plant that is affected, for example, roots, seeds, stems, flowers, or fruits. Furthermore, the compositions can be contacted with an entire plant, and/or to the environment surrounding the plant, such as the soil.

The microbes can be either live (or viable) or inactive at the time of application. When utilizing live microbes, the microbes can grow in situ and produce the active compounds onsite. Consequently, a high concentration of microorganisms can be achieved easily and continuously at a treatment site (e.g., a garden). In this way, the methods can further comprise adding materials to enhance microbe growth during application. In one embodiment, the added materials are nutrient sources, such as, for example, sources of nitrogen, nitrate, phosphorus, magnesium and/or carbon.

In some embodiments, the method comprises contacting the affected plant with the microorganism and/or the growth by-products in the fermentation medium in which they were produced. In some embodiments, the method comprises simply applying the fermentation medium and/or the microbial growth by-product to the plant. The growth by-products can be purified or in crude form. In preferred embodiments, the growth by-product is a biosurfactant, such as a glycolipid or a lipopeptide. In one exemplary embodiment, the biosurfactant is a sophorolipid.

The method can further comprise applying one or more substances to enhance pathogen controlling effects, such as, for example, an adherent substance to prolong the adherence of the product to the plant.

Advantageously, the present invention can be used without releasing large quantities of inorganic compounds into the environment. Additionally, the compositions and methods utilize components that are biodegradable and toxicologically safe. Thus, the present invention can be used for treating viral and bacterial plant pathogens as a “green” treatment.

### DETAILED DESCRIPTION OF THE INVENTION

The subject invention provides microbes, as well as by-products of their growth, such as biosurfactants, for use in treating certain plant pathogenic infections. In particular, the subject invention provides compositions and methods for treatment of plant pathogenic viruses, including mosaic virus, as well as plant pathogenic bacteria, using beneficial microbes and/or their growth by-products. Advantageously, the microbe-based products and methods of the subject invention are environmentally-friendly, non-toxic and cost-effective.

### Selected Definitions

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of microbial propagule, or a mixture of these. The microbes may be planktonic or in a biofilm form, or a mixture of both. The by-products of growth may be, for example, metabolites (e.g., biosurfactants), cell membrane components, expressed proteins, and/or other cellular components. The microbes may be intact or lysed. The cells may be totally absent, or present at, for example, a concentration of 1×10⁴, 1×10⁵, 1×10⁶, 1×10⁷, 1×10⁸, 1×10⁹, 1×10¹⁰, 1×10¹¹, 1×10¹², 1×10¹³ or more cells or propagules per milliliter of the composition. As used herein, a propagule is any portion of a microorganism from which a new and/or mature organism can develop, including but not limited to, cells, conidia, cysts, spores (e.g., reproductive spores, endospores and exospores), mycelia, buds and seeds.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, carriers (e.g., water or salt solutions), added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “harvested” refers to removing some or all of the microbe-based composition from a growth vessel.

As used herein, a “biofilm” is a complex aggregate of microorganisms, such as bacteria, wherein the cells adhere to each other. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein, organic compound such as a small molecule (e.g., those described below), or other compound is substantially free of other compounds, such as cellular material, with which it is associated in nature. For example, a purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. A purified or isolated microbial strain is removed from the environment in which it exists in nature. Thus, the isolated strain may exist as, for example, a biologically pure culture, or as spores (or other forms of the strain) in association with a carrier.

As used here in, a “biologically pure culture” is one that has been isolated from materials with which it is associated in nature. In a preferred embodiment, the culture has been isolated from all other living cells. In further preferred embodiments, the biologically pure culture has advantages characteristics compared to a culture of the same microbe as it exists in nature. The advantages characteristics can be, for example, enhanced production of one or more by-products of their growth.

In certain embodiments, purified compounds are at least 60% by weight (dry weight) the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites can include, but are not limited to, enzymes, toxins, acids, solvents, alcohols, proteins, carbohydrates, vitamins, minerals, microelements, amino acids, polymers, and surfactants.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” refers to a negative alteration of at least 1%, 5%, 10%, 25%, 50%, 75%, or 100%.

As used herein, “reference” refers to a standard or control condition.

As used herein, “surfactant” refers to a compound that lowers the surface tension (or interfacial tension) between two liquids or between a liquid and a solid. Surfactants act as, e.g., detergents, wetting agents, emulsifiers, foaming agents, and dispersants. A “biosurfactant” is a surfactant produced by a living organism.

As used herein, “agriculture” means the cultivation and breeding of plants and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture is the care, monitoring and maintenance of soil.

As used herein, a “pathogenic” organism is any organism that is capable of causing a disease in another organism. Typically, pathogenic organisms are infectious agents and can include, for example, bacteria, viruses, fungi, molds, protozoa, prions, parasites, helminths, and algae.

As used herein, a “pest” is any organism, other than a human, that is destructive, deleterious and/or detrimental to humans or human concerns (e.g., agriculture, horticulture, livestock production, aquaculture). In some, but not all instances, a pest may be a pathogenic organism. Pests may cause or be a vector for infections, infestations and/or disease, or they may simply feed on or cause other physical harm to living tissue. Pests may be single- or multi-cellular organisms, including but not limited to, viruses, fungi, bacteria, parasites, and/or nematodes.

As used herein, “treatment” means the eradicating, improving, reducing, ameliorating or reversing a sign or symptom of a disease, condition or disorder. Treatment can include, but does not require, a complete cure of the disease, condition or disorder, meaning treatment can also include partial eradication, improvement, reduction, amelioration or reversal. Furthermore, treatment can include delaying the onset of the signs or symptoms of a disease, condition or disorder, or delaying the progression of the disease, condition or disorder to a more severe disease, condition or disorder.

As used herein, the term “control” used in reference to a pathogen or pest extends to the act of killing, disabling, immobilizing, or reducing population numbers of the pathogen and/or pest, or otherwise rendering the pathogen and/or pest substantially incapable of causing disease or other harm.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Microbe-Based Compositions

The subject invention provides microbe-based compositions, wherein the compositions comprise one or more beneficial microorganisms and/or one or more microbial growth by-products. The composition may comprise the fermentation medium in which the microorganisms and/or growth by-products were produced. The microbial growth by-products can be those produced by the microorganisms of the composition, or they can be produced elsewhere and added to the composition.

Advantageously, the microbe-based compositions according to the subject invention are non-toxic (i.e., ingestion toxicity is more than 5 g/kg) and can be applied in high concentrations without causing irritation to, for example, skin or the digestive tract. Thus, the subject invention is particularly useful where application of the microbe-based compositions occurs in the presence of living organisms, such as farmers and growers.

In certain embodiments, the subject invention utilizes a biosurfactant-producing microorganism. The beneficial microorganisms may be in an active or inactive form, or the composition may contain a combination of active and inactive microorganisms.

In specific embodiments, the microbe is a biosurfactant-producing yeast, such as, for example, Starmerella bombicola. In another embodiment, the microorganism is a biosurfactant-producing killer yeast, for example, Pichia anomala (Wickerhamomyces anomalus). These yeasts are effective producer of glycolipid biosurfactants.

In one embodiment, the beneficial microorganism is a biosurfactant-producing bacteria, such as Bacillus subtilis or Bacillus amyloliquefaciens. These species are effective producers of certain lipopeptide biosurfactants.

In certain embodiments, the composition can comprise fermentation broth containing a live and/or an inactive culture and/or the microbial metabolites produced by the microorganism and/or any residual nutrients. The product of fermentation may be used directly without extraction or purification. If desired, extraction and purification can be easily achieved using standard extraction and/or purification methods or techniques described in the literature.

Furthermore, the composition may be, for example, at least, by weight, 1%, 5%, 10%, 25%, 50%, 75%, or 100% broth. The biomass content of the fermentation broth may be, for example from 5 g/l to 180 g/l or more, or anywhere from 0% to 100% inclusive of all percentages therebetween. In one embodiment, the solids content of the broth is from 10 g/l to 150 g/l.

In one embodiment, the composition comprises only a microbial growth by-product. It can be in a purified or crude (e.g., unpurified) form.

In some embodiments, the growth by-product of the subject composition is a biosurfactant. The biosurfactants can be, for example, glycolipid biosurfactants, including sophorolipids (SLP), mannosylerythritol lipids (MEL), rhamnolipids (RLP) and/or trehalose lipids (TL). The biosurfactants can also be lipopeptides such as, for example, surfactin, iturin, fengycin and/or lichenysin.

In certain embodiments, the glycolipid is a SLP, a MEL or a combination thereof. MEL are abundantly produced by, for example, Pseudozyma aphidis. SLP are produced by, for example, Starmerella yeasts and Pichia yeasts.

In certain embodiments, the biosurfactants are SLP. There exist at least eight structurally different sophorolipids. The chemical composition an SLP is formed by a sophorose and a fatty acid or an ester group. Macrolactone and free acid structures are acetylated to various extents at the primary hydroxyl position of the sophorose ring. The main component of a sophorolipid is 17-hydroxyoctadecanoic acid and its corresponding lactone. Additionally, unsaturated C-18 fatty acids of oleic acid may be transferred unchanged into sophorolipids.

In some embodiments, a natural mixture of sophorolipids can be synthesized by fermentation of S. bombicola.

In some embodiments, crude form biosurfactants can take the form of a liquid mixture comprising biosurfactant precipitate in fermentation broth resulting from cultivation of a biosurfactant-producing microbe. This crude form biosurfactant solution can comprise from about 0.001% to about 75%, from about 30% to about 70%, from about 35% to about 65%, from about 40% to about 60%, from about 45% to about 55%, or about 50% pure biosurfactant.

In certain embodiments, the concentration of biosurfactant, e.g., SLP, in the subject composition ranges from 0.001% to 5.0%, preferably from 0.1% to 0.5%, or 0.2%.

The beneficial microbes and microbe-based compositions of the subject invention have a number of properties that are useful for treating viral and bacterial plant pathogenic diseases, including mosaic virus. For example, biosurfactants according to the subject invention can inhibit microbial adhesion to a variety of surfaces, prevent the formation of biofilms, and can have powerful emulsifying and demulsifying properties.

In certain embodiments, the compositions of the subject invention have advantages over, for example, purified microbial metabolites alone, due to one or more of the following: high concentrations of mannoprotein (an emulsifier) as a part of a yeast cell wall's outer surface; the presence of beta-glucan (also an emulsifier) in yeast cell walls; and the presence of biosurfactants, solvents and/or other metabolites in the culture (e.g., lactic acid, ethanol, etc.).

Further components can be added to the microbe-based composition to enhance its anti-pathogenic activity. Preferably, these additives are considered organic or environmentally-friendly. For example, adherence substances, human/animal antiviral compounds, antibacterial compounds, essential oils, terpenes, emulsifiers, chelating agents, or any other anti-pathogenic substance can be included in the composition.

Additives can also include buffering agents, carriers, other microbe-based compositions produced at the same or different facility, viscosity modifiers, preservatives, nutrients for microbe growth, tracking agents, biocides, other microbes, surfactants, emulsifying agents, lubricants, solubility controlling agents, pH adjusting agents, preservatives, stabilizers and ultra-violet light resistant agents.

In one embodiment, the composition can further comprise buffering agents, including organic and amino acids or their salts, to stabilize pH near a preferred value. Suitable buffers include, but are not limited to, citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and mixtures thereof. Phosphoric and phosphorous acids or their salts may also be used. Synthetic buffers are suitable to be used but it is preferable to use natural buffers such as organic and amino acids or their salts.

In a further embodiment, pH adjusting agents include potassium hydroxide, ammonium hydroxide, potassium carbonate or bicarbonate, hydrochloric acid, nitric acid, sulfuric acid and mixtures thereof.

The pH of the microbe-based composition should be suitable for the microorganism of interest. In certain embodiments, the pH of the final microbe-based composition ranges from 5.0 to 9.0, from 6.0 to 8.0, or preferably from 7.0 to 7.5.

In one embodiment, additional components such as an aqueous preparation of a salt, such as sodium bicarbonate or carbonate, sodium sulfate, sodium phosphate, or sodium biphosphate, can be included in the microbe-based composition.

In certain embodiments, the microbe-based composition of the subject invention further comprises a carrier. The carrier may be any suitable carrier known in the art that permits the yeasts or yeast by-products to be delivered to target plants and/or soil.

In further embodiments the yeast product is supplied in the form of, for example, liquid suspensions, emulsions, freeze or spray dried powders, granules, pellets, or gels.

The microbe-based compositions may be used without further stabilization, preservation, and storage after they have been produced. Advantageously, direct usage of these microbe-based compositions preserves a high viability of the microorganisms, reduces the possibility of contamination from foreign agents and undesirable microorganisms, and maintains the activity of the by-products of microbial growth.

The microbes and/or broth resulting from the microbial growth can be removed from the growth vessel in which cultivation occurs and transferred via, for example, piping for immediate use.

In other embodiments, the composition (microbes, broth, or microbes and broth) can be placed in containers of appropriate size, taking into consideration, for example, the intended use, the contemplated method of application, the size of the fermentation tank, and any mode of transportation from microbe growth facility to the location of use. Thus, the containers into which the microbe-based composition is placed may be, for example, from 1 gallon to 1,000 gallons or more. In certain embodiments the containers are 2 gallons, 5 gallons, 25 gallons, or larger.

Upon harvesting the microbe-based composition from the growth vessels, further components can be added as the harvested product is placed into containers and/or piped (or otherwise transported for use). The additives can be, for example, those described herein, as well as others, such as prebiotics, soil amendments, and other ingredients specific for an intended use.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

### Microbial Strains

The beneficial microorganisms according to the subject invention can be, for example, non-pathogenic bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In preferred embodiments, the microbes are biochemical-producing microbes, capable of producing, for example, biosurfactants and/or other useful metabolites.

In one embodiment, the microorganism is a yeast or fungus. Yeast and fungus species suitable for use according to the current invention, include Aureobasidium (e.g., A. pullulans), Blakeslea, Candida (e.g., C. apicola, C. bombicola), Entomophthora, Saccharomyces (e.g., S. boulardii sequela, S. cerevisiae, S. torula), Issatchenkia, Mortierella, Mycorrhiza, Penicillium, Phycomyces, Pseudozyma (e.g., P. aphidis), Starmerella (e.g., S. bombicola), and/or Trichoderma (e.g., T reesei, T harzianum, T hamatum, T viride).

In certain embodiments, the microorganism is any yeast known as a “killer yeast” characterized by its secretion of toxic proteins or glycoproteins, to which the strain itself is immune. These can include, for example, Candida (e.g., C. nodaensis), Cryptococcus, Debaryomyces (e.g., D. hansenii), Hanseniaspora, (e.g., H. uvarum), Hansenula, Kluyveromyces (e.g., K. phaffii), Pichia (e.g., P. anomala, P. guielliermondii, P. occidentalis, P. kudriavzevii), Saccharomyces (e.g., S. cerevisiae), Torulopsis, Ustilago (e.g., U. maydis), Wickerhamomyces (e.g., W. anomalus), Williopsis (e.g., W. mrakii), Zygosaccharomyces (e.g., Z. bailii), and others.

In one embodiment, the microorganism is Starmerella bombicola, which is an effective producer of sophorolipid biosurfactants. In another embodiment, the subject invention utilizes killer yeasts, such as, for example, Wickerhamomyces anomalus (Pichia anomala). Other closely related species are also envisioned, e.g., other members of the Starmerella, Wickerhamomyces and/or Pichia clades.

In certain embodiments, the beneficial microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquifaciens, B. firmus, B. laterosporus, B. licheniformis, B. megaterium, B. mucilaginosus, B. subtilis), Frateuria (e.g., F. aurantia), Microbacterium (e.g., M. laevaniformans), Pantoea (e.g., P. agglomerans), Pseudomonas (e.g., P. aeruginosa, P. chlororaphis subsp. auregfaciens (Kluyver), P. putida), Rhizobium spp., Rhodospirillum (e.g., R. rubrum), and/or Sphingomonas (e.g., S. paucimobilis).

In one embodiment, the microorganism is a strain of Bacillus capable of producing a lipopeptide biosurfactant, such as, for example, B. subtilis or B. amyloliquefaciens.

In one embodiment, the strain of B. subtilis is B. subtilis var. lotuses B1 or B2, which are effective producers of, for example, surfactin and other biosurfactants, as well as biopolymers. This specification incorporates by reference International Publication No. WO 2017/044953 A1 to the extent it is consistent with the teachings disclosed herein.

Other microbial strains including, for example, other strains capable of accumulating significant amounts of biosurfactants, mannoprotein, beta-glucan, and/or other useful metabolites, can be used in accordance with the subject invention.

### Growth of Microbes According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids (e.g., a submerged matrix) and/or combinations thereof.

As used herein “fermentation” refers to cultivation or growth of cells under controlled conditions. The growth could be aerobic or anaerobic.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam when gas is produced during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The method and equipment for cultivation of microorganisms and production of the microbial by-products can be performed in a batch, a quasi-continuous process, or a continuous process.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

In the case of submerged fermentation, the biomass content of the fermentation broth may be, for example, from 5 g/l to 180 g/l or more. In one embodiment, the solids content of the broth is from 10 g/l to 150 g/l.

The cell concentration may be, for example, 1×10⁹, 1×10¹⁰, 1×10¹¹, 1×10¹² or 1×10¹³ cells or spores per gram of final product.

The microbial growth by-product produced by microorganisms of interest may be retained in the microorganisms or secreted into the growth medium. The medium may contain compounds that stabilize the activity of microbial growth by-product.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Preparation of Microbe-Based Products

One microbe-based product of the subject invention is simply the fermentation broth containing the microorganism and/or the microbial metabolites produced by the microorganism and/or any residual nutrients. The product of fermentation may be used directly without extraction or purification. If desired, extraction and purification can be easily achieved using standard extraction and/or purification methods or techniques described in the literature.

The microorganisms in the microbe-based product may be in an active or inactive form. The microbe-based products may contain combinations of active and inactive microorganisms.

The microbes, microbial growth by-products and/or broth resulting from the microbial growth can be removed from the growth vessel and transferred via, for example, piping for immediate use.

In other embodiments, the composition (microbes, metabolites, and/or broth) can be placed in containers of appropriate size, taking into consideration, for example, the intended use, the contemplated method of application, the size of the fermentation tank, and any mode of transportation from microbe growth facility to the location of use. Thus, the containers into which the microbe-based composition is placed may be, for example, from 1 gallon to 1,000 gallons or more. In other embodiments the containers are 2 gallons, 5 gallons, 25 gallons, or larger.

Upon harvesting the microbe-based composition from the growth vessels, further components can be added as the harvested product is placed into containers and/or piped (or otherwise transported for use). The additives can be, for example, those described herein, as well as other, such as, emulsifying agents, lubricants, solubility controlling agents, pH adjusting agents, prebiotics, soil amendments, and other ingredients specific for an intended use.

In one embodiment, the composition may further comprise buffering agents including organic and amino acids or their salts. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt as polyprotic acid such as sodium bicarbonate or carbonate, sodium sulfate, sodium phosphate, sodium biphosphate, can be included in the formulation.

Advantageously, in accordance with the subject invention, the microbe-based product may comprise broth in which the microbes were grown. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

Further components can be added to the microbe-based composition to enhance its anti-pathogenic activity. Preferably, these additives are considered organic or environmentally-friendly. For example, adherent substances, human/animal antiviral compounds, antibacterial compounds, essential oils, terpenes, emulsifiers, chelating agents, or any other anti-pathogenic substance can be included in the composition. In extreme cases, for example, for large-scale devastation of a particular crop, antibiotics and/or antiviral medications can also be used alongside the subject treatment.

In certain embodiments, an adherent substance can be added to the treatment to prolong the adherence of the product to plant leaves. Polymers, such as charged polymers, or polysaccharide-based substances can be used, for example, xanthan gum, guar gum, levan, xylinan, gellan gum, curdlan, pullulan, dextran and others.

In preferred embodiments, commercial grade xanthan gum is used as the adherent. The concentration of the gum should be selected based on the content of the gum in the commercial product. If the xanthan gum is highly pure, then 0.001% (w/v—xanthan gum/solution) is sufficient.

In certain embodiments, for example, if treatment is not as effective as desired against Gram-negative bacteria, the subject treatment products can be enhanced for treating plant pathogenic Gram-negative bacterial diseases by adding a chelating agent.

As used herein, “chelating agent” or “chelator” means an active agent capable of removing a metal ion from a system by forming a complex so that the metal ion cannot readily participate in or catalyze oxygen radical formation. Advantageously, the chelating agent enhances the efficacy of an antimicrobial biosurfactant by modifying the cell walls of, for example, Gram-negative bacteria, to be more susceptible to surfactant treatment. Consequently, the ability to permeate Gram-negative bacteria broadens the spectrum of treatment capabilities for the subject invention.

Examples of chelating agents suitable for the present invention include, but are not limited to, dimercaptosuccinic acid (DMSA), 2,3-dimercaptopropanesulfonic acid (DMPS), alpha lipoic acid (ALA), thiamine tetrahydrofurfuryl disulfide (TTFD), penicillamine, ethylenediaminetetraacetic acid (EDTA), and citric acid. In preferred embodiments, the chelating agent is EDTA in concentration of 0.1 to 1.0% (v/v).

Methods of Treating Viral and Bacterial Plant Pathogens The present invention can be used to enhance cultivation of plants by treating infections, infestations and/or diseases of plants and/or crops in, for example, agriculture, horticulture, greenhouses, landscaping, and the like. Advantageously, the methods can be used for controlling pathogens and/or for preventing the spread of such organisms from one plant to another.

In some embodiments, methods are provided for treating mosaic virus and/or bacterial plant pathogens, wherein the methods comprise contacting a beneficial microorganism and/or a growth by-product of the microorganism with a part of a plant that is infected by the pathogen. In certain embodiments, the method comprises applying a microbe-based composition according to the subject description to the plant. Advantageously, the composition can kill, reduce, competitively inhibit the growth of, and/or control by any other means, a plant pathogen. Furthermore, the methods can improve immune and/or pathogenic defense of plants without use of harsh chemicals or antibiotics.

As used herein, “application” of the subject methods can include contacting the microbe-based product directly with a plant and/or its surrounding environment. The microbe-product can be sprayed as a liquid or a dry powder, or applied as a gel or paste to the plant. The soils can be treated with liquid or dry formulations of the products, for example, through the irrigation system as a liquid solution, or as soluble granules or pellets.

The microbe-based composition can be contacted directly with a plant and/or with the plant's surrounding environment. In certain embodiments, application comprises contacting the microbe-based product with the leaves, or foliage of an infected plant. In other embodiments, the compositions are contacted with any part of the plant that is affected, for example, roots, stems, flowers, or fruits. Furthermore, the compositions can be contacted with an entire plant, and/or to the environment surrounding the plant, such as the soil.

In one embodiment, the method comprises applying a microbe-based product comprising Starmerella bombicola yeast and/or its growth by-products to a plant or part of a plant. In another embodiment, the beneficial microorganism is Wickerhamomyces anomalus. In yet another embodiment, the beneficial microorganism is a lipopeptide-producing bacteria, such as, for example, Bacillus subtilis or Bacillus amyloliquefaciens.

The microbes can be either live (or viable) or inactive at the time of application. When utilizing live microbes, the microbes can grow in situ and produce the active compounds onsite. Consequently, a high concentration of microorganisms can be achieved easily and continuously at a treatment site (e.g., a garden). In this way, the methods can further comprise adding materials to enhance microbe growth during application. In one embodiment, the added materials are nutrient sources, such as, for example, sources of nitrogen, nitrate, phosphorus, magnesium and/or carbon.

In some embodiments, the method comprises contacting the affected plant with the microorganism and/or the growth by-products in the fermentation medium in which they were produced. In some embodiments, the method comprises simply applying the fermentation medium and/or the microbial growth by-product to the plant. The growth by-products can be purified or in crude form. In preferred embodiments, the growth by-product is a biosurfactant, such as a glycolipid or a lipopeptide. In one exemplary embodiment, the biosurfactant is a sophorolipid.

The method can further comprise applying one or more substances to enhance pathogen controlling effects, such as, for example, an adherent substance to prolong the adherence of the product to the plant. In one embodiment, the adherent substance is xanthan gum. Other substances that can be applied with the composition include, for example, environmentally-friendly or organic substances with antiviral and/or antibacterial properties, essential oils, terpenes, emulsifiers, chelating agents, or any other anti-pathogenic substances. In extreme cases, for example, for large-scale devastation of a particular crop, antibiotics and/or antiviral medications can also be applied alongside the subject treatment.

### Target Pathogens

In addition to all forms of mosaic virus, examples of viral infection affecting plants, against which the subject invention is useful, include, but are not limited to, Carlavirus, Abutilon, Hordeivirus, Potyvirus, Mastrevirus, Badnavirus, Reoviridae, Fijivirus, Oryzavirus, Phyloreovirus, Mycoreovirus, Rymovirus, Tritimovirus, Ipomovirus, Bymovirus, Cucumovirus, Luteovirus, Begomovirus, Rhabdoviridae, Tospovirus, Comovirus, Sobemovirus, Nepovirus, Tobravirus, Benyvirus, Furovirus, Pecluvirus, Pomovirus; alfalfa mosaic virus; beet mosaic virus; cassava mosaic virus; cowpea mosaic virus; cucumber mosaic virus; panicum mosaic satellite virus; plum pox virus; squash mosaic virus; tobacco mosaic virus; tulip breaking virus; and zucchini yellow mosaic virus.

Examples of bacterial infections affecting plants, against which the subject invention is useful, include, but are not limited to, Pseudomonas (e.g., P. savastanoi, Pseudomonas syringae pathovars); Ralstonia solanacearum; Agrobacterium (e.g., A. tumefaciens); Xanthomonas (e.g., X. oryzae pv. oryzae; X. campestris pathovars; X. axonopodis pathovars); Erwinia (e.g., E. amylovora); Xylella (e.g., X. fastidiosa); Dickeya (e.g., D. dadantii and D. solani); Pectobacterium (e.g., P. carotovorum and P. atrosepticum); Clavibacter (e.g., C. michiganensis and C. sepedonicus); Candidatus Liberibacter asiaticus; Pantoea; Ralstonia; Burkholderia; Acidovorax; Streptomyces; Spiroplasma; and Phytoplasma.

The microbe-based products can be used either alone or in combination with other compounds for efficient treatment of pathogenic pests, including viruses such as mosaic virus, and bacteria. SLP treatment is less effective against Gram-negative bacteria than against other pests and/or microorganisms; however, the subject treatment products can be enhanced for treating plant pathogenic gram-negative bacterial diseases. This can be accomplished by adding a chelating agent to the product.

### Target Plants

As used herein, “plant” refers to any plant used in agriculture as defined herein. The plant can be standing alone, for example, in a garden, or it can be one of many plants, for example, as part of an orchard or farm crop. Example of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef; Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. saliva, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T. durum, T. turgidum, T. hybernum, T macha, T. sativum, T monococcum or T. vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca saliva), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a fish farm). For example, the microbe growth facility may be less than 300, 250, 200, 150, 100, 75, 50, 25, 15, 10, 5, 3, or 1 mile from the location of use.

Because the microbe-based product is generated on-site or near the site of application, without the requirement of stabilization, preservation, prolonged storage and extensive transportation processes of conventional production, a much higher density of live microorganisms can be generated, thereby requiring a much smaller volume of the microbe-based product for use in an on-site application. This allows for a scaled-down bioreactor (e.g., smaller fermentation tank; smaller supplies of starter material, nutrients, pH control agents, and de-foaming agent, etc.), which makes the system efficient. Furthermore, local production facilitates the portability of the product.

Local generation of the microbe-based product also facilitates the inclusion of the growth broth in the product. The broth can contain agents produced during the fermentation that are particularly well-suited for local use.

Locally-produced high density, robust cultures of microbes are more effective in the field than those that have undergone vegetative cell stabilization or have sat in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the broth in which the microbes are grown. If desired, the compositions can have a high density of vegetative cells, inactivated cells, or a mixture of vegetative cells, inactivated cells, reproductive spores, mycelia and/or other microbial propagules. Advantageously, the compositions can be tailored for use at a specified location. In one embodiment, the microbe growth facility is located on, or near, a site where the microbe-based products will be used.

Advantageously, these microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell- and/or propagule-count product and the associated broth and metabolites in which the microbes are originally grown.

Advantageously, in preferred embodiments, the systems of the subject invention harness the power of naturally-occurring local microorganisms and their metabolic by-products to treat plant pathogenic bacteria. Local microbes can be identified based on, for example, salt tolerance, ability to grow at high temperatures, and the use of genetic identification of sequences. Additionally, the microbe growth facilities provide manufacturing versatility by their ability to tailor the microbe-based products to improve synergies with destination geographies.

The cultivation time for the individual vessels may be, for example, from 1 day to 2 weeks or longer. The cultivation product can be harvested in any of a number of different ways.

Local production and delivery within, for example, 24 hours of fermentation results in pure, high microbe density compositions and substantially lower shipping costs. Given the prospects for rapid advancement in the development of more effective and powerful microbial inoculants, consumers will benefit greatly from this ability to rapidly deliver microbe-based products.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Sophorolipid Fermentation

For this invention, a natural mixture of sophorolipids is synthesized by fermentation of S. bombicola in a fermentation medium containing 100 g glucose, 5 g yeast extract, 1 g urea and 100 g canola oil in 1000 ml of water. After 5-7 days of fermentation, sophorolipid is collected by precipitation. After adding additional amounts of the same nutrient medium, fermentation continues for another 3 days, after which another portion of SLP is collected.

Two different products are produced from this fermentation process: one comprising pure SLP and one comprising S. bombicola culture containing SLP.

### Example 2—Preparation of SLP Solution for Foliar Treatment

Precipitated SLP obtained by S. bombicola fermentation can be used to produce a product for treatment of plants for all types of mosaic viruses. The precipitated SLP usually contains up to 50% water; however, no further concentration is needed prepare this type of treatment product. The treatment product contains from 0.1 to 0.5% (v/v) of the unpurified SLP.

### Example 3—Preparation of SLP Solution Containing S. bombicola Cells for Foliar Treatment

Another type of treatment product can use the S. bombicola culture to treat mosaic viruses, as well as other microbial pathogens, such as pathogenic Gram-positive bacteria. The culture can be produced in portable, distributable reactors, which can provide for local production of the product in close proximity to an application site.

The cultivation process produces 250 gallons of pure S. bombicola culture containing up to 4 g/L of SLP. The resulting culture is diluted at least 10 times, producing at least 2,500 gallons of treatment product.

### Example 4—Treatment of Cucumber Plant Infected with Mosaic Virus

The subject invention was used to treat cucumber plants infected with a mosaic virus. The leaves of the cucumber plants were treated with a composition comprising 0.2% SLP. The SLP composition was sprayed onto the surfaces of the leaves for a period of three days.

The mosaic spots present on the leaves disappeared and the leaves looked healthy in less than five days after the beginning of treatment.

### Example 5—SLP Treatment of Gram-Positive Bacteria

Petri dishes with a loan of gram-positive bacteria Bacillus subtilis were treated with 0.5% solution of SLP. In 2 days after treatment, a halo with no culture growth (more than half an inch in diameter) was observed.

1-27. (canceled)

28. A method for treating a viral and/or bacterial disease of a plant, the method comprising applying to a plant a composition comprising a microorganism and/or a growth by-product thereof, wherein the microorganism is a biosurfactant-producing yeast or bacteria, and the growth by-product is a biosurfactant.

29. The method of claim 28, wherein the yeast is Starmerella bombicola or Wickerhamomyces anomalus.

30. The method of claim 28, wherein the bacteria is Bacillus subtilis or Bacillus amyloliquefaciens.

31. The method of claim 28, wherein the composition comprises fermentation broth in which the microorganism was grown and/or the growth by-product was produced.

32. The method of claim 31, wherein the composition comprises the fermentation broth without the microorganism.

33. The method of claim 28, wherein the biosurfactant is a glycolipid or lipopeptide.

34. The method of claim 33, wherein the glycolipid is selected from sophorolipids, rhamnolipids, mannosylerythritol lipids, and trehalose lipids.

35. The method of claim 33, wherein the lipopeptide is selected from surfactin, iturin, lichenysin and fengycin.

36. The method of claim 33, wherein the biosurfactant is a sophorolipid at a concentration of 0.1% to 0.5%.

37. The method of claim 28, wherein the composition further comprises an adherent substance.

38. The method of claim 37, wherein the adherent substance is a polysaccharide selected from xanthan gum and guar gum.

39. The method of claim 38, wherein the polysaccharide is xanthan gum at a concentration of 0.001% (w/v).

40. The method of claim 28, wherein the viral disease is Carlavirus, Abutilon, Hordeivirus, Potyvirus, Mastrevirus, Badnavirus, Reoviridae, Fijivirus, Oryzavirus, Phytoreovirus, Mycoreovirus, Rymovirus, Tritimovirus, Ipomovirus, Bymovirus, Cucumovirus, Luteovirus, Begomovirus, Rhabdoviridae, Tospovirus, Comovirus, Sobemovirus, Nepovirus, Tobravirus, Benyvirus, Furovirus, Pecluvirus, Pomovirus; alfalfa mosaic virus; beet mosaic virus; cassava mosaic virus; cowpea mosaic virus; cucumber mosaic virus; panicum mosaic satellite virus; plum pox virus; squash mosaic virus; tobacco mosaic virus; tulip breaking virus; or zucchini yellow mosaic virus.

41. The method of claim 28, wherein the viral disease is a mosaic virus selected from alfalfa mosaic virus; beet mosaic virus; cassava mosaic virus; cowpea mosaic virus; cucumber mosaic virus; panicum mosaic satellite virus; plum pox virus; squash mosaic virus; tobacco mosaic virus; tulip breaking virus; and zucchini yellow mosaic virus.

42. The method of claim 28, wherein the bacterial disease is Pseudomonas savastanoi; Pseudomonas syringae pathovars; Ralstonia solanacearum; Agrobacterium tumefaciens; Xanthomonas oryzae pv. oryzae; Xanthomonas campestris pathovars; Xanthomonas axonopodis pathovars; Erwinia amylovora; Xylella fastidiosa; Dickeya dadantii; Dickeya solani; Pectobacterium carotovorum; Pectobacterium atrosepticum; Clavibacter michiganensis; Clavibacter sepedonicus; Candidatus Liberibacter asiaticus; Pantoea; Ralstonia; Burkholderia; Acidovorax; Streptomyces; Spiroplasma; or Phytoplasma

43. The method of claim 28, wherein the plant is an alfalfa, apple, bean, beet, cassava, celery, corn, cucumber, fig, pepper, spinach, squash, tobacco, tomato, zucchini, petunia, rose, or tulip plant.

44. The method of claim 28, wherein the composition is applied to the plant's leaves or foliage.

45. The method of claim 28, wherein the method comprises contacting the fermentation broth, separated from the beneficial microorganism, with the plant.
